(19) United States
(12) Patent Application Publication
(10) Pub. No.: US 2010/0075751 A1
(43) Pub. Date: Mar. 25, 2010

(54) NETWORK DIAGNOSTICS IN A WAGERING GAME SYSTEM

(75) Inventors: Jesse Garvey, Chicago, IL (US); Jason A. Smith, Vernon Hills, IL (US); Timothy D. Wilson, Oak Park, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/527,751

(22) PCT Filed: Feb. 15, 2008
(86) PCT No.: PCT/US08/02123

§ 371 Date: Aug. 19, 2009

Related U.S. Application Data
(60) Provisional application No. 60/890,514, filed on Feb. 19, 2007.

(51) Int. Cl. A63F 13/00; A63F 9/24

(52) U.S. Cl. 463/30; 463/25; 463/42; 463/43

(57) ABSTRACT

This document discusses, among other things, systems and methods for network diagnostics in a wagering game system. A method comprises presenting a wagering game upon which monetary value can be wagered; and determining the state of a network connection between the wagering game system and a networked device, wherein determining the state comprises analyzing a message received from the networked device.

### RELATED APPLICATION

This patent application claims the priority benefit of U.S. Provisional Patent Application Ser. No. 60/890,514 filed Feb. 19, 2007 and entitled “NETWORK DIAGNOSTICS IN A WAGERING GAME SYSTEM”, which application is incorporated herein by reference.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2007, 2008, WMS Gaming, Inc.

### FIELD

Embodiments of the inventive subject matter relate generally to wagering game systems, and more particularly, to wagering game systems including network diagnostics.

### BACKGROUND

Wagering game machine makers continually provide new and entertaining games. One way of increasing entertainment value associated with casino-style wagering games (e.g., video slots, video poker, video black jack, and the like) includes offering a variety of base games and bonus events. In addition to stand-alone, single-player type games, casino floors are increasingly being populated with interconnected, networked wagering games. As these machines have grown more complex, additional tools are needed to maintain and administrate them.

### BRIEF DESCRIPTION OF THE FIGURES

Embodiments of the invention are illustrated by way of example and not limitation in the figures of the accompanying drawings in which:

FIG. 1 is a block diagram illustrating a wagering game machine architecture, including a control system, according to example embodiments;

FIG. 2 is a block diagram illustrating an architecture for a wagering game machine, according to example embodiments;

FIG. 3 is a block diagram illustrating a wagering game network, according to example embodiments;

FIG. 4 is a diagram illustrating a configuration of operational modes of a wagering game machine, according to example embodiments;

FIG. 5 is a diagram illustrating a service mode screen, according to example embodiments;

FIG. 6 is a diagram illustrating an information screen, according to example embodiments;

FIG. 7 is a diagram illustrating a monitor screen, according to example embodiments;

FIG. 8 is a diagram illustrating a discovery screen, according to example embodiments;

FIG. 9 is a diagram illustrating a diagnostic mode screen, according to example embodiments;

FIG. 10 is an example of a test report screen for a network category, according to example embodiments;

FIG. 11 is a diagram illustrating a communication test screen, according to example embodiments;

FIG. 12 is a data flow diagram illustrating a test transmission, according to example embodiments;

FIG. 13 is a diagram illustrating a relationship between network protocol stacks, according to example embodiments;

FIG. 14 is a diagram illustrating a component test screen, according to example embodiments;

FIG. 15 is a diagram illustrating a remote test screen, according to example embodiments;

FIG. 16 is a control flow diagram illustrating a one-way test mode, according to example embodiments;

FIG. 17 is a control flow diagram illustrating a two-way test mode, according to example embodiments;

FIG. 18 is an example use of a one-way mode test to detect network connectivity failure, according to example embodiments;

FIG. 19 is a flowchart illustrating a method of using a network diagnostic interface in a wagering game machine, according to example embodiments;

FIG. 20 is a perspective view of a wagering game machine, according to example embodiments; and

FIG. 21 is a perspective of a mobile wagering game machine, according to example embodiments.

### DESCRIPTION OF THE EMBODIMENTS

### Example Operating Environment

### Example Wagering Game Machine Architecture

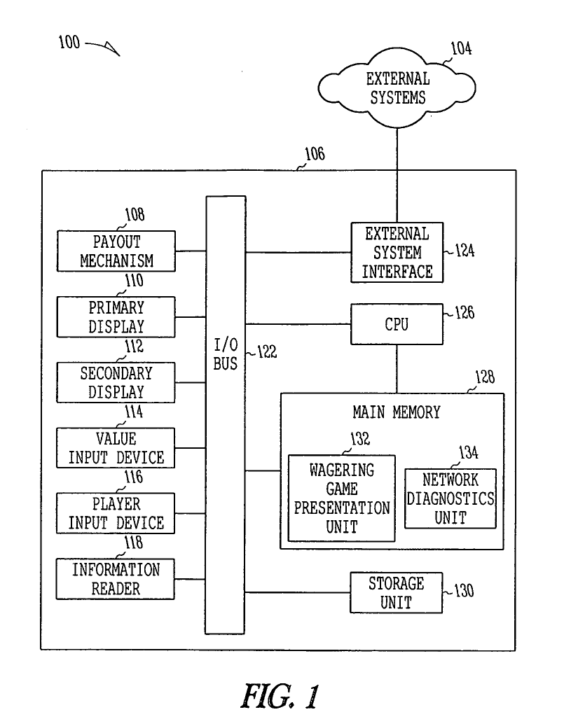

FIG. 1 is a block diagram illustrating a wagering game machine architecture, including a control system, according to example embodiments. As shown in FIG. 1, the wagering game machine 106 includes a central processing unit (CPU) 126 connected to main memory 128, which includes a wagering game presentation unit 132 and a network diagnostics unit 134. In one embodiment, the wagering game presentation unit 132 can present wagering games, such as video poker, video black jack, video slots, video lottery, etc., in whole or part. In an embodiment, the network diagnostics unit 134 can present one or more network management interfaces, such as a diagnostic interface, a monitoring interface, a testing interface, a status interface, a network discovery interface, a statistics interface, or an information interface.

The CPU 126 is also connected to an input/output (I/O) bus 122, which facilitates communication between the wagering game machine's components. The I/O bus 122 is connected to a payout mechanism 108, primary display 110, secondary display 112, value input device 114, player input device 116, information reader 118, and storage unit 130. The player input device 116 may include the value input device 114 to the extent the player input device 116 is used to place wagers. The I/O bus 122 is also connected to an external system interface 124, which is connected to external systems 104 (e.g., wagering game networks).

In one embodiment, the wagering game machine 106 may include additional peripheral devices and/or more than one of each component shown in FIG. 1. For example, in one embodiment, the wagering game machine 106 may include multiple external system interfaces 124 and multiple CPUs 126. In one embodiment, any of the components may be integrated or subdivided. Additionally, in one embodiment, the components of the wagering game machine 106 may be interconnected according to any suitable interconnection architecture (e.g., directly connected, hypercube, etc.).

In one embodiment, any of the components of the wagering game machine 106 can include hardware, firmware, and/or software for performing the operations described herein. Machine-readable media includes any mechanism that provides (e.g., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

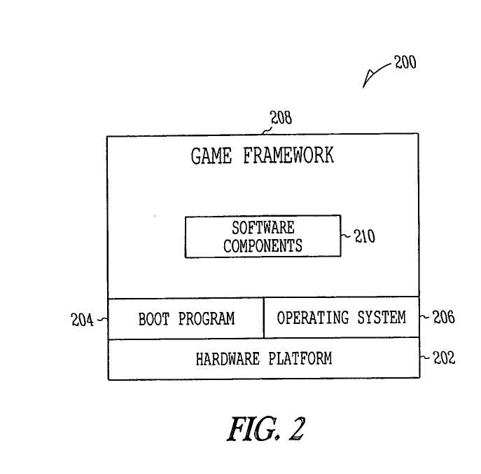

Referring now to FIG. 2, there is illustrated a block diagram of an architecture for a wagering game machine 200, according to example embodiments of the inventive subject matter. As shown in FIG. 2, the wagering game architecture includes a hardware platform 202, a boot program 204, an operating system 206, and a game framework 208 that includes one or more wagering game software components 210. In various embodiments, the hardware platform 202 may include a thin-client, thick-client, or some intermediate derivation. The hardware platform 202 may also be configured to provide a virtual client. The boot program 204 may include a basic input/output system (BIOS) or other initialization program that works in conjunction with the operation system 206 to provide a software interface to the hardware platform 202. The operating system 206 may include native or custom software components that interface with a network (e.g., ping, ipconfig, ifconfig, tracert, nslookup, “net” commands, etc.). The game framework 208 may include standardized game software components either independent or in combination with specialized or customized game software components that are designed for a particular wagering game. In one example embodiment, the wagering game software components 210 may include software operative in connection with the hardware platform 202 and operating system 206 to present wagering games, such as video poker, video black jack, video slots, video lottery, etc., in whole or part. According to another example embodiment, the software components 210 may include software operative to accept a wager from a player. In an embodiment, software components 210 can include network management software to monitor, detect, discover, test, report, or repair network components or networking-related information. According to another example embodiment, one or more of the software components 210 may be provided as part of the operating system 206 or other software used in the wagering game system 200 (e.g., libraries, daemons, common services, etc.).

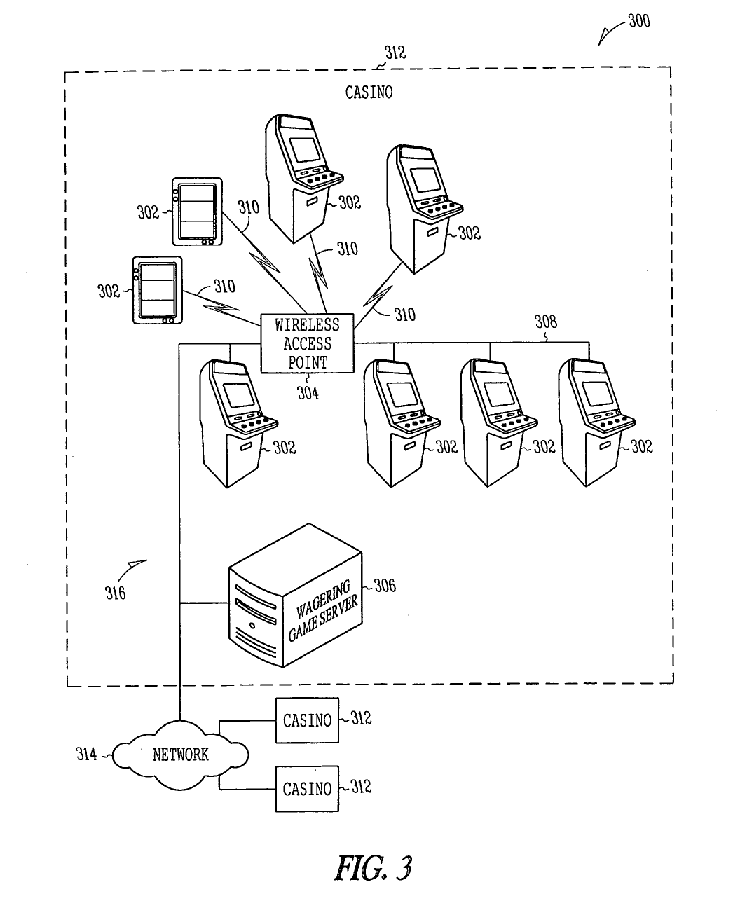

While FIGS. 1 and 2 describe example embodiments of a wagering game machine architecture, FIG. 3 shows how a plurality of wagering game machines can be connected in a wagering game network.

### Example Wagering Game Network

FIG. 3 is a block diagram illustrating a wagering game network 300, according to example embodiments. As shown in FIG. 3, the wagering game network 300 includes a plurality of casinos 312 connected to a communications network 314.

Each of the plurality of casinos 312 includes a local area network 316, which may include a wireless access point 304, wagering game machines 302, and a wagering game server 306 that can serve wagering games over the local area network 316. As such, the local area network 316 includes wireless communication links 310 and wired communication links 308. The wired and wireless communication links can employ any suitable connection technology, such as Bluetooth, 802.11, Ethernet, public switched telephone networks, SONET, etc. In one embodiment, the wagering game server 306 can serve wagering games and/or distribute content to devices located in other casinos 312 or at other locations on the communications network 314.

The wagering game machines 302 and wagering game server 306 can include hardware and machine-readable media including instructions for performing the operations described herein.

The wagering game machines 302 described herein can take any suitable form, such as floor standing models, handheld mobile units, bartop models, workstation-type console models, etc. Further, the wagering game machines 302 can be primarily dedicated for use in conducting wagering games, or can include non-dedicated devices, such as mobile phones, personal digital assistants, personal computers, etc. In one embodiment, the wagering game network 300 can include other network devices, such as accounting servers, wide area progressive servers, player tracking servers, and/or other devices suitable for use in connection with embodiments.

In various embodiments, wagering game machines 302 and wagering game servers 306 work together such that a wagering game machine 302 may be operated as a thin, thick, or intermediate client. For example, one or more elements of game play may be controlled by the wagering game machine 302 (client) or the wagering game server 306 (server). Game play elements may include executable game code, lookup tables, configuration files, game outcome, audio or visual representations of the game, game assets or the like. In a thin-client example, the wagering game server 306 may perform functions such as determining game outcome or managing assets, while the wagering game machine 302 may be used merely to present the graphical representation of such outcome or asset modification to the user (e.g., player). In a thick-client example, game outcome may be determined locally (e.g., at the wagering game machine 302) and then communicated to the wagering game server 306 for recording or managing a player's account.

Similarly, functionality not directly related to game play may be controlled by the wagering game machine 302 (client) or the wagering game server 306 (server) in embodiments. For example, power conservation controls that manage a display screen's light intensity may be managed centrally (e.g., by the wagering game server 306) or locally (e.g., by the wagering game machine 302). Other functionality not directly related to game play may include presentation of advertising, software or firmware updates, system quality or security checks, etc.

### Example Operations

In various embodiments, a wagering game machine can include one or more operational modes. The primary operational mode of a wagering game machine is a game play mode. Other modes may be available, for example, to install or remove games, update system or other support software, or to manage the software and hardware associated with the wagering game machine.

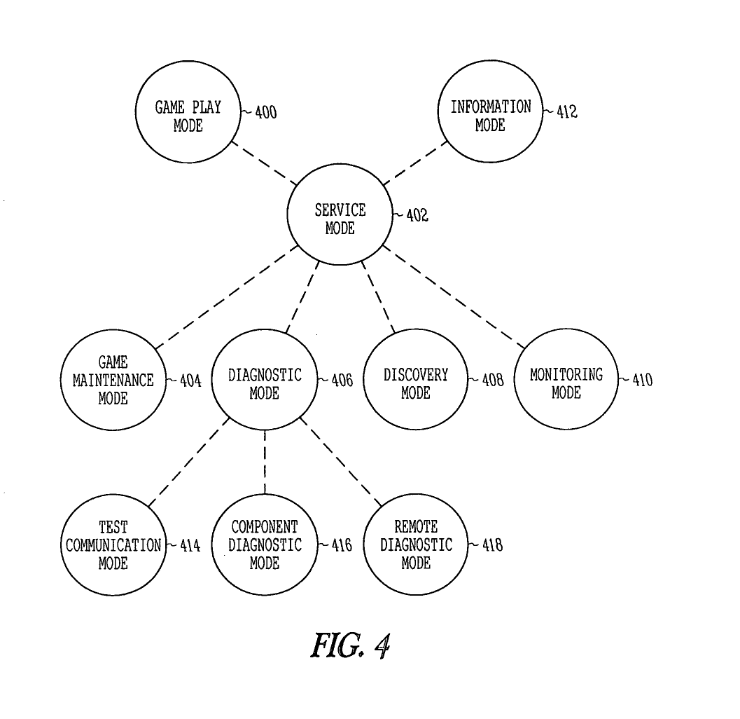

FIG. 4 is a diagram illustrating a configuration of operational modes of a wagering game machine, according to example embodiments. During the majority of a wagering game machine's use, the machine is in a game play mode 400. In game play mode 400, one or more wagering games can be presented to one or more users (e.g., players). Wagering games may include single-player games or community games. Occasionally, the wagering game machine may be set to a service mode 402. In service mode 402, an operator may perform maintenance on the wagering game machine, for example, to install or uninstall a game file, reset the operation of a game or a game machine, or check the status of various components of the wagering game machine, such as network software or hardware, operating system components, or the like. In an embodiment, the service mode 402 may be configured as an operational center or “jumping off point” for one or more specific service operations. Service operations may include a game maintenance, diagnostic evaluation, or monitoring. In the configuration illustrated in FIG. 4, service operations correspond to one or more operational modes that include a game maintenance mode 404, a diagnostic mode 406, a discovery mode 408, a monitoring mode 410, and an information mode 412. In addition, in the configuration shown, the diagnostic mode 406 may serve as a root for a test communication mode 414, a component diagnostic mode 416, and a remote diagnostic mode 418.

In game maintenance mode 404, the operator is provided with an interface, such as a graphical user interface (GUI), to add, remove, install, uninstall, configure, or otherwise alter or manage games on a wagering game machine. For example, a wagering game machine may be capable of presenting several wagering games to a player. The player may then choose which game to play for a particular game play session. To increase the amount of game play on a wagering game machine, an operator can use the game maintenance mode 404 of the service mode 402 to change the games available to attract more players or different types of players. As another example, the operator may change a game's operation from a demonstration mode to a game play mode, where game play is emulated in the demonstration mode.

In diagnostic mode 406, the operator is presented with an interface to test one or more components of wagering game machine. For example, the operator can test hardware components (e.g., video, storage, processing, memory, networking, game reels, etc.) or software components (e.g., operating system, game software, game-support software, etc.). In addition, the operator can test other networked wagering game machines, in some configurations of some embodiments.

In test communication mode 414, the operator is presented with an interface to send and/or receive test communication (e.g., packets) to another device networked to the wagering game machine. The other device may include another wagering game machine, a wagering game server, or an external networked device. For example, an operator may cause the wagering game machine to send one or more test packets to a recipient machine over a network to test connectivity, speed, routing, or other aspects of the communication. In addition, the recipient machine, or other machine, may send one or more test packets, which may be in response to the initial test packet, to the wagering game machine, with which the wagering game machine may derive information of the communication.

In component diagnostic mode 416, the operator is presented with an interface to test one or more components in the wagering game machine. The tests may be configured to test one or more components individually or in combination. Tests may also be constructed by the operator to test a selected component or group of components. While some component testing may be available in the diagnostic mode 406, in an embodiment, more detailed and/or lower-level testing is only available in the component diagnostic model 416.

In remote diagnostic mode 418, the operator is presented with an interface to remotely operate or remotely test another machine on the network. In an embodiment, the operator may be presented with an interface emulating the remote machine, which the operator can then control using the local controls. For example, the remote machine's service menu may be presented in an interface. In an embodiment, the operator is presented information from the remote machine's perspective, but the operator is not provided using an emulated interface. For example, the operator is presented with network latency values to one or more networked nodes from the remote machine's perspective.

In discovery mode 408, the operator is presented with an interface to detect, map, and display a network topology. The network topology may be used in other modes, such as, for example, in the diagnostic mode 406, to provide a portion of a graphic user interface. In an embodiment, the network topology includes one or more nodes, which may be networked (connected) using wired or wireless communication technologies. Nodes may include hubs, switches, routers, gateways, servers, wagering game machines, wagering game servers, and the like. Servers may include non-proprietary servers, such as DHCP (Dynamic Host Configuration Protocol), DNS (Domain Name System), LDAP (Lightweight Directory Access Protocol), and NTP (Network Time Protocol) servers. Servers may also include proprietary servers, such as random number generator servers, WAP (Wide-Area Progressive) servers, SAS (Slot Accounting System) servers as provided by IGT, Inc., SDS (Slot Data System) servers as provided by Acres Gaming, and host servers as provided by Gtech Corporation. Servers may also include certificate servers (e.g., X.509), download servers, file servers, etc.

In monitoring mode 410, the operator is presented with an interface to monitor hardware, software, network, or other conditions of, or related to, the wagering game machine. For example, the operator may be presented with a real-time display of network throughput, system memory usage, main memory usage, disk space usage, processor load, or the like. In some embodiments, some or all of the information provided in the monitoring mode 410 may be presented in other modes, such as the game play mode 400, service mode 402, game maintenance mode 404, diagnostic mode 406, or information mode 412.

In information mode 412, the operator is presented with an interface to explore detailed or summary information. For example, statistical information may be provided to an operator, who can then print out the information, erase the information, or compile reports or other views of the information. As another example, detailed information may be presented to the operator. Detailed information can include things, such as a processor model or version, an operating system version, a game version, network configuration information, total wagering game operation time, hardware component information (e.g., model numbers, version numbers, or serial numbers of devices or components), or the like.

Data related to one or more operational modes may be saved to a local storage device (e.g., a hard drive or removable storage media) or to a network storage device (e.g., a wagering game server). Data may be analyzed online or offline and the results of the analysis may be provided to the wagering game machine. In embodiments, operational modes are implemented using one or more user-interfaces. Additional details of these interfaces are illustrated and described below.

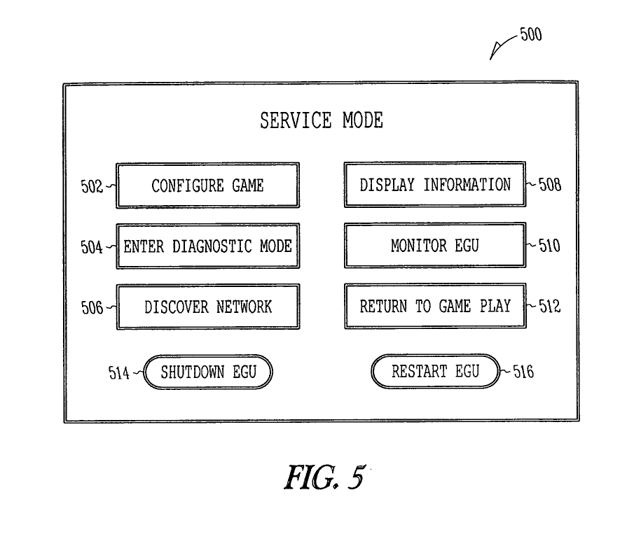

FIG. 5 is a diagram illustrating a service mode screen 500, according to example embodiments. In an embodiment, the service mode screen 500 is displayed when a user enters the service mode 402. In the example shown, the service mode screen 500 includes several elements, including a configure games control 502, an enter diagnostic mode control 504, a discover network control 506, a display information control 508, a monitor EGU (electronic gaming unit) control 510, and a return to game play control 512. An operator can use the configure games control 502 to enter a game maintenance mode 404 and access one or more user interfaces to manage, control, or modify games associated with the wagering game machine. Similarly, the operator can use the diagnostic mode control 504 to enter a diagnostic mode 406 to perform tests or otherwise evaluate a wagering game machine. The discover network control 506 can be used to enter a discovery mode 408 to search for networked devices and map a network topology. The display information control 508 can be used to enter an information mode 412 to obtain detailed or summary information related to the wagering game machine or wagering games on the wagering game machine. The monitor EGU control 510 can be used to enter a monitoring mode 410 to monitor one or more aspects of the wagering game's operation. The return to game play control 512 exits the service mode 402 and returns the operation of the wagering game machine to game play mode 400.

In some embodiments, the service mode screen can include other controls to adjust or control game play or game machine operation, such as the shutdown control 514 and the restart control 516. Using the shutdown control 514, the operator may properly and completely power down a wagering game machine. Using the restart control 516, the operator may perform a shutdown and then power on the machine. The shutdown and/or the restart operations may be used, for example, to reset the operation of the wagering game machine when it becomes unstable, such as when a game crashes, locks up, or is otherwise inaccessible or inoperable.

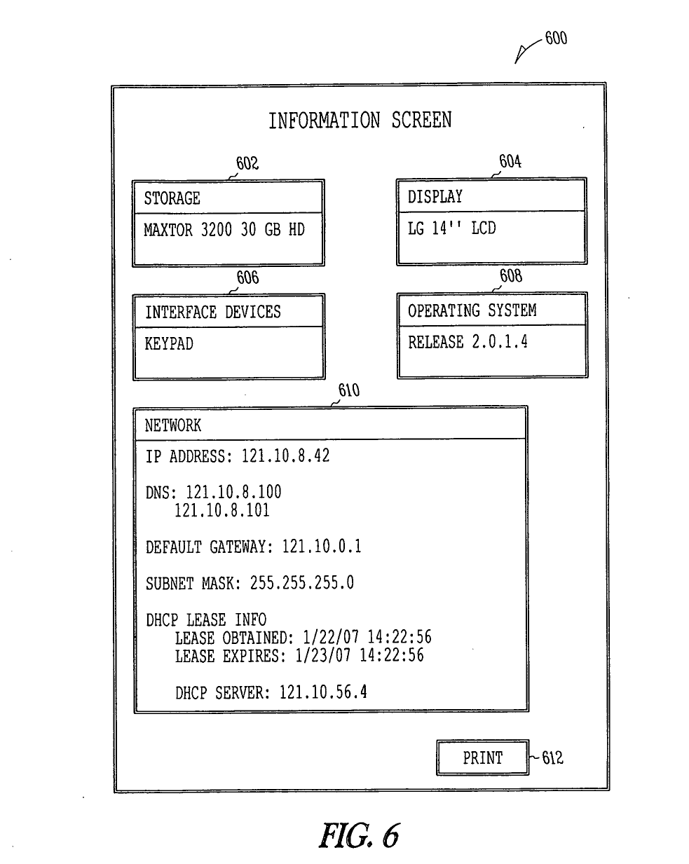

FIG. 6 is a diagram illustrating an information screen 600, according to example embodiments. In an embodiment, the information screen 600 is displayed when a user is in the information mode 412. In the example illustrated in FIG. 6, several views are presented, including storage 602, display 604, interface 606, operating system 608, and network 610. The storage view 602 can include information related to fixed and removable storage devices associated with the machine. Similarly, the display view 604 can include device information related to a primary and secondary display device. The network view 610 may include configuration information, such as the machine's IP address, MAC address, subnet mask, primary and secondary DNS servers, local DNS server address, global DNS server address, gateway address, or DHCP lease information. In addition, the network view 610 can include information related to proprietary networks. In embodiments, more or fewer categories may be displayed. The categories may be displayed using a single screen interface or a multi-screen interface that may use popup screens, one or more sub-screens for each component, or a split screen to show categories in one screen and detailed information in one or more screens presented in split screens. In an embodiment, the information screen 600 includes a print control 612. Using the print control 612, a user may print out some or all of the information displayed on the information screen 600. In various embodiments, the print job is routed either locally (e.g., to a ticket printer or a card dispenser on the wagering game machine) or remotely (e.g., to a printing device in a server room). The information may be printed physically (e.g., using a paper ticket) or electronically (e.g., storing information on a magnetic card media or a flash drive, or emailing the printed requested information).

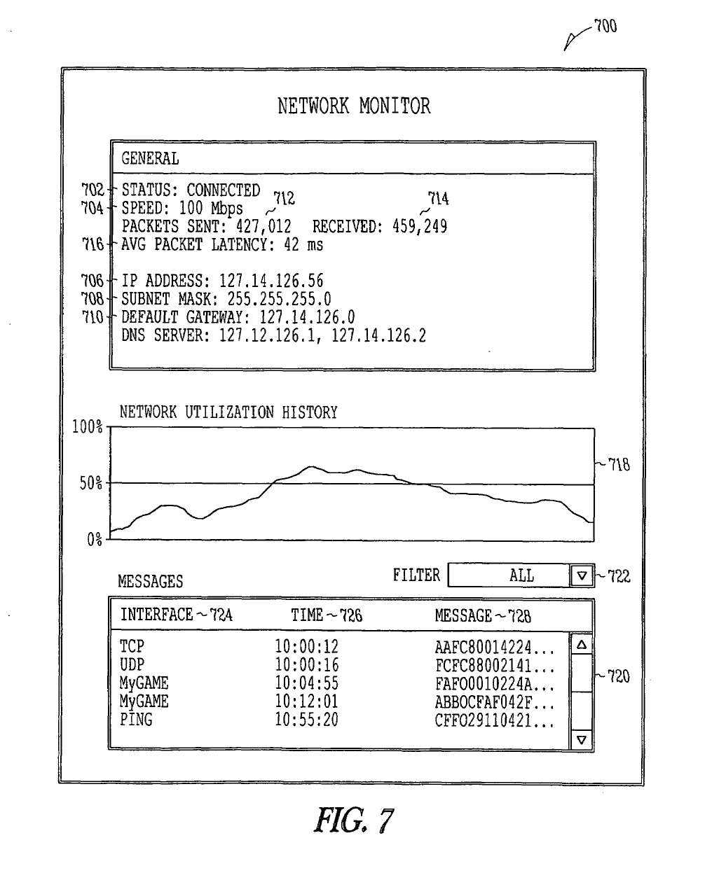

FIG. 7 is a diagram illustrating a monitor screen 700, according to example embodiments. In an embodiment, the monitor screen 700 is displayed when a user is in monitoring mode 410. The monitor screen 700 can display information related to game information or performance, wagering game machine information or performance, network information or performance, or other configuration information. In the example shown, the monitor screen 700 is configured to display networking configuration and performance information. General information, such as the network connection status 702, network connection speed 704, IP address 706, subnet mask 708, and default gateway 710 can be displayed. In addition, basic statistics, such as the number of packets sent 712 or received 714 may be maintained and displayed along with an average packet latency 716. The average packet latency 716 may reflect one-way communication delay using received packets or by using a round-trip calculation, such as by using a ping mechanism in various embodiments. The average packet latency 716 may include packet latency from any connected node on the network or may be restricted to packet latency to or from a central server (e.g., wagering game server), in embodiments.

The monitor screen 700 may also include one or more graphical charts 718 showing a historical view of a parameter (e.g., average latency, network utilization, etc.). Using the historical chart may enable an operator to identify a problematic situation earlier or easier than without a chart available. In an embodiment, network monitoring may occur in the background, for example, while game play is executing, and some or all of the information available on the monitor screen 700 may be available on the game display during game play. For example, an animated meter (e.g., a bar meter, a dial meter, or a color meter) may be displayed on the game-play screen in an innocuous position.

The monitor screen 700 may also include a list view 720 of one or more messages. Messages may include inter-node messages or intra-node messages (e.g., inter-process or intra-process messages), in embodiments. In an embodiment, a filter control 722 can be used to list a particular subset of available messages. For example, a user may be interested in capturing, recording, or reviewing messages to or from a particular process on the wagering game machine. The filter control 722 may be configured to filter the messages obtained by the monitor screen 700 such that only messages to or from the particular process are displayed. Filters may be based on process names, process IDs, protocol (e.g., UDP messages, TCP messages, ICMP messages, SMNP messages, etc.), interface (e.g., Ethernet, gigabit Ethernet, Token Ring, virtual interfaces, such as a router control-plane interface or a loopback, or other physical interfaces, such as Fast Ethernet, ATM, IEEE 802.11, etc.), network port (e.g., 23 (Telnet), 443 (HTTPS), 8080 (HTTP), 161 (SNMP), 22 (SSH), etc.), message size, message transmission time, message destination, message origin, or other characteristics of the message or interface used to transmit or receive the message. In the example shown, the list view 720 includes an interface column 724, a transmit time column 726, and a message column 728. The interface column 724 can display the process ID, protocol identifier, or the like. The message column 728 can display the beginning portion of the message transmitted, for example, the first twenty characters. In various embodiments, the message may be displayed in hexadecimal, binary, ASCII, or other character representations. To view the entire message, in an embodiment, the user may activate the list entry, for example by double clicking the entry or hovering the cursor over the entry, and a popup window containing the message may be displayed. In other embodiments, the entire message may be displayed in a separate screen or a split screen.

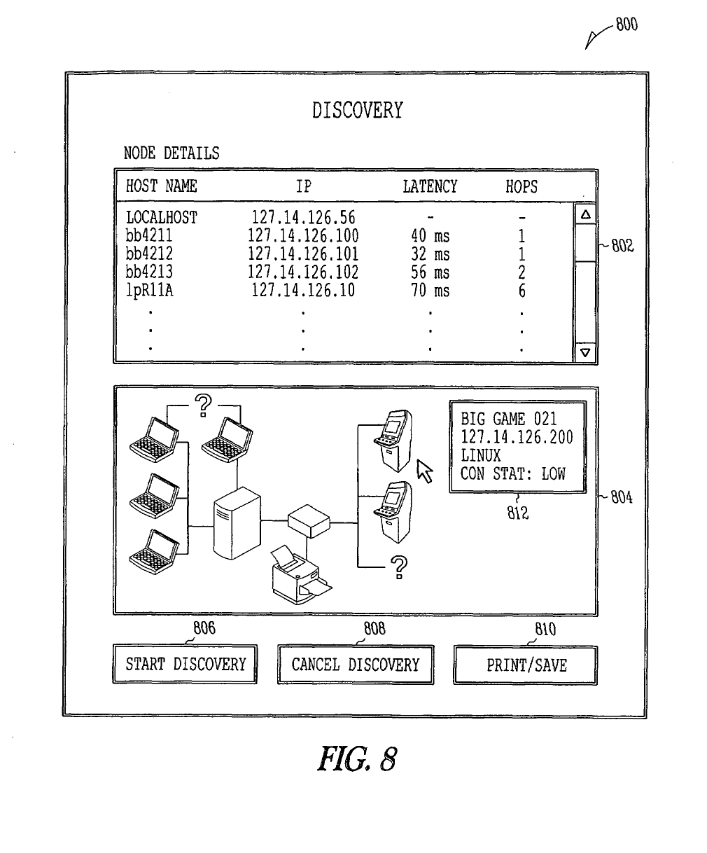

FIG. 8 is a diagram illustrating a discovery screen 800, according to example embodiments. In an embodiment, the discovery screen 800 is displayed when a user is in discovery mode 408. In the example shown, the discovery screen 800 includes table 802 and a graphical network map 804. The discovery screen 800 may also include a start discovery control 806, a cancel discovery control 808, and a print/save control 810. Activating the start discovery control 806 begins a scan for other nodes on the network and maps discovered nodes to the graphical portion 804. Nodes discovered during the scan are also listed in the table 802. During discovery, the user may cancel the discovery scan using the cancel discovery control 808. This may be useful when processing has stalled or hung, or when the user only wanted to discover a portion of the network.

Information displayed in the table 802 may be a view of network information that includes default information and user-selected information. For example, default information may include the node's hostname and IP address. In an embodiment, default information is always presented in the table 802 for a user. In addition to default information, a user may select one or more aspects of data, for example, to display in one or more columns that may be displayed in the table 802. User-selectable information may include detected or sensed information, such as the number of network hops to the discovered node from the current node, latency between the current node and the discovered node, the type of connection, the protocol used, the relationship between the current node and the discovered node, the operating system on the discovered node, wagering game details of the discovered node, hardware or software configuration details of the discovered node, or the like. In addition, in various embodiments, default information or user-selectable information is configurable. For example, a user may decide to display the latency in different units (e.g., seconds). As another example, a user may be able to configure the interface, such as by sorting the table 802 on one or more columns in ascending or descending order, or by reordering the columnar format. In an embodiment, a user may sort on a particular field by clicking the field header. In an embodiment, all information displayed, such as in table 802, is user-selectable or configurable.

The graphical network map 804 can be dynamically updated to display network nodes as they are discovered. Nodes may include wagering game machines, wagering game servers, routers, switches, hubs, firewalls, proxy servers, printing devices, wireless access points, repeaters, and the like. In an embodiment, the nodes are displayed using appropriate icons. For example, wagering game machines may be depicted as an upright standing game machine, whereas routers, switches, or hubs may be depicted as a slim-profiled unit with a row of status lights on the front. As another example, network connections with high latency may be displayed in a particular color (e.g., red) and connections with low latency may be displayed in another color (e.g., green). Other artistic or conventional icons may be used to allow the user to identify characteristics of the network node quickly and easily.

In an embodiment, when a user moves a cursor of the network node, a popup window 812 or other sub-window is displayed with detailed information about the selected node. For example, the popup window 812 may display the node's hostname, IP address, operating system, and connection status. The connection status may be an indication based on the latency, network load, processor load, memory usage, or other conditions extant on the selected node. For example, if the selected node is experiencing a large amount of network activity, which burdens the system's responsiveness below a threshold value, a connection status of “LOW” (e.g., using a scale of “LOW,” GOOD,” and “EXCELLENT”) may be displayed in the popup window 812.

In an embodiment, a baseline or reference network topology is determined and stored. As other discovery operations occur, the results may be compared to the baseline topology. If there is a discrepancy, the user may be alerted. Referencing a baseline may detect intruder nodes or other unauthorized activity on a network. Referencing a baseline may also provide an indication of an improperly configured node that is resulting in an undesirable topology (e.g., having redundant connections). If the user determines that the discrepancy is a new configuration that is permissible, then the newly discovered topology may be saved as a new baseline model.

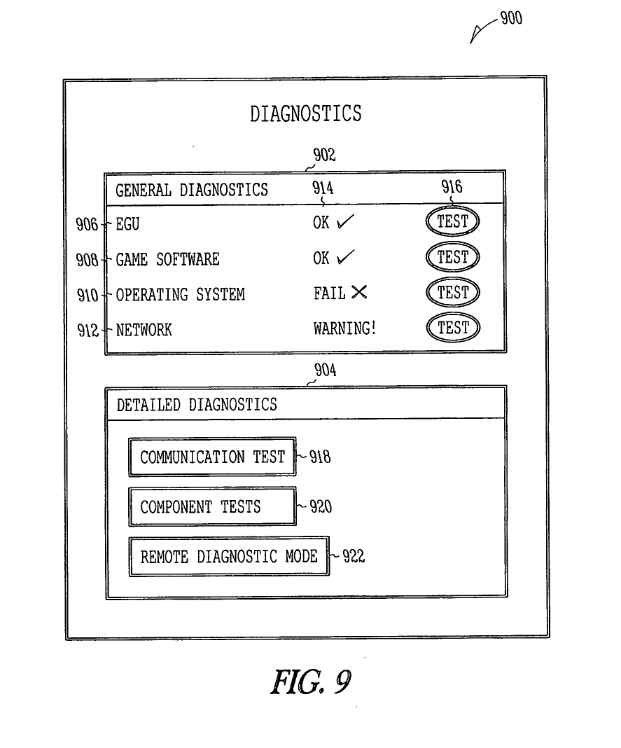

FIG. 9 is a diagram illustrating a diagnostic mode screen 900, according to example embodiments. In an embodiment, the diagnostic mode screen 900 is displayed when a user is in diagnostic mode 406. In an embodiment, the diagnostic mode screen 900 includes a general diagnostics area 902 and a detailed diagnostics area 904. The general diagnostics can be used to obtain an overall indication of machine or network operation. For example, as illustrated in FIG. 9, the wagering game machine's components may be divided into several broad categories, such as “EGU” 906, “Game Software” 908, “Operating System” 910, and “Network” 912. A indication of overall health 914 is provided for each broad category. The indication may be represented as a textual, iconic, or other graphical form. In the example shown, three levels are used to indicate overall health ranging from “FAILED,” as the worst condition, to “WARNING,” as a cautionary condition, to “OK” as the best condition. In addition, corresponding icons are displayed. The indication of overall health 914 (e.g., text or icons) may be colored or shaped to provide quick reference. Also, a test control 916 that corresponds to each broad category is shown. Using the appropriate test control 916, a user can initiate the test of the corresponding category. Activating a test control 916 may initiate one or more tests that diagnose whether the component is operating within an acceptable range. For example, using the test control 916 to test the network 912 may test the connection status, connection speed, and signal strength. If the speed or signal strength is below a threshold value, the indication of overall health 914 may be set to “WARNING.” If the connection status is unconnected, then the indication of overall health 914 may be set to “FAILED.” Threshold values may be set at the wagering game machine, e.g., by using a portion of the service mode interface, or at a central system, e.g., a wagering game server. Threshold values may also be determined at the installation of software (e.g., game, game framework, or operating system software). Some threshold values may not be modified by a user, e.g., factory pre-set, while others may be dynamically configurable.

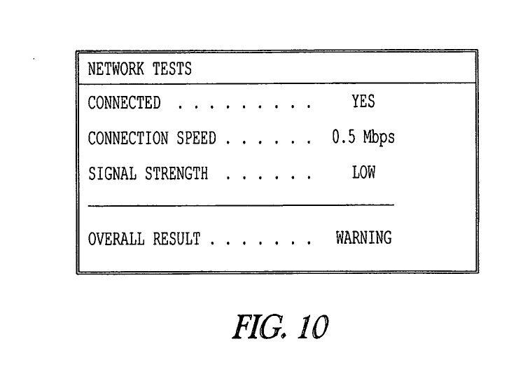

In some embodiments, a user may review details of a general diagnosis. Details may include the results of one or more tests performed in a suite of tests to diagnose the general condition of a broad category. For example, when a user activates (e.g., click on) or moves a cursor over the network category 912, a new screen may appear, either as a popup screen or as a replacement screen, showing the tests executed and each test's result. FIG. 10 is an example of a test report screen for a network category, according to example embodiments.

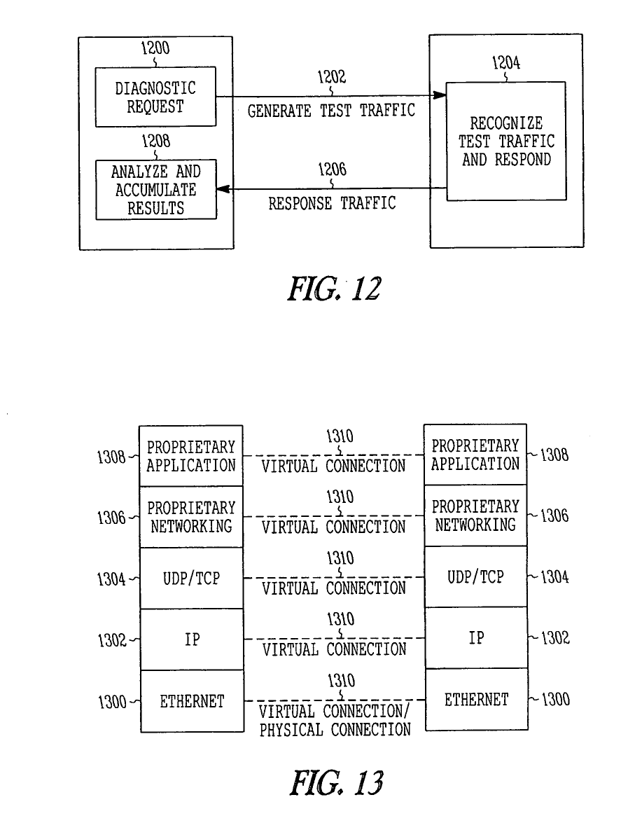

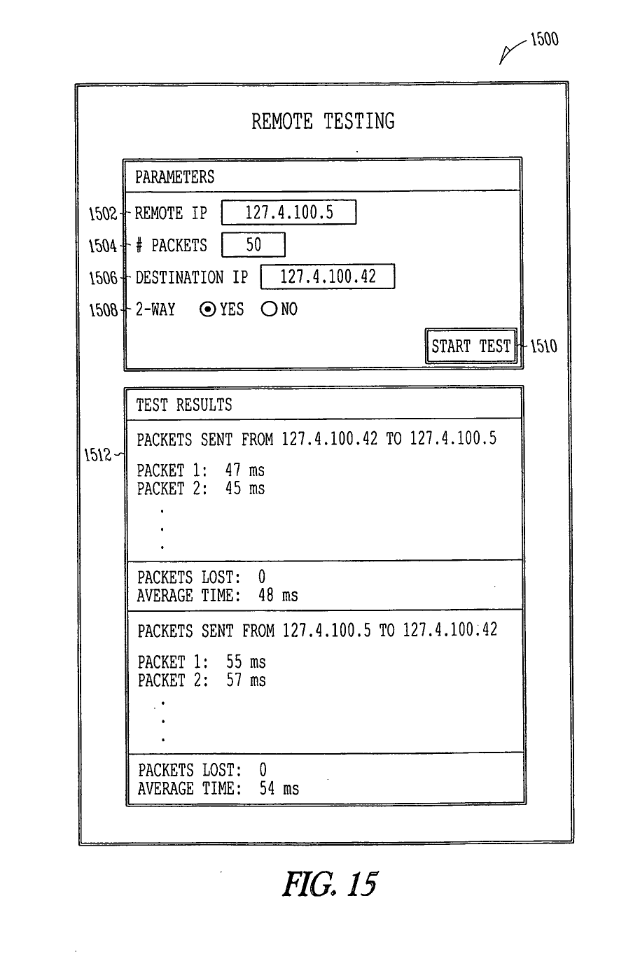

The detailed diagnostics area 904 can contain one or more controls to provide the user access to additional diagnostic testing. In the example shown, the detailed diagnostics area 904 includes a communication test control 918, a component tests control 920, and a remote diagnostic mode control 922. Activating the communication test control 918 can navigate the user to an interface that provides control over point-to-point communication testing, as described below with reference to FIG. 11. Activating the component tests control 920 can navigate the user to an interface for testing various components of a wagering game machine, such as the networking, software, and hardware components. Component testing is described in further detail below with reference to FIG. 13. Activating the remote diagnostic mode control 922 can navigate the user to an interface to test a remote node on the network. Additional features are described below with reference to FIG. 15.

FIG. 11 is a diagram illustrating a communication test screen 1100, according to example embodiments. In an embodiment, the communication test screen 1100 is displayed when a user is in communication test mode 414. For reference, the local IP address 1102 is displayed to the user. The target IP address 1104 is the address of the node where the test packets will be sent. The transmit (TX) rate 1106 is the frequency of the transmissions, measured in milliseconds in this example. A user may change the target IP address or the TX rate using the corresponding change target IP control 1108 or change TX rate control 1110. In an embodiment, the target IP address may be the local IP address, so the user can perform on-node or loopback testing. To begin a test, the user activates a start test control 1112. In an embodiment, the test continues to run until the user terminates it using a stop test control 1114. In another embodiment, the user may provide a number of transmissions or a time period to constrain the testing to a certain scope. For example, the user may configure the test to run for three minutes or 2000 transmissions, whichever happens first. In various embodiments, the test transmissions are accomplished using a utility program, such as ping, or using a proprietary client-server software program.

As the test runs, the summary section 1116 is updated. In the example shown, the summary section 1116 includes the number of packets sent, received, and lost. The summary section 1116 also includes the number of rude packets. Rude packets are a measurement of packets sent to the local machine from a third party machine while the local machine is in test communication with the target machine. A total run time of the test is also displayed in the summary section 1116. In the example shown in FIG. 11, a histogram is provided in a chart 1118. The histogram displays an approximation of the number of packets received in a particular transmission time 1120. In the example shown, the transmission time is the round trip time in milliseconds. In other examples, the transmission time may be a one-way transmission time or may be measured in other units. The percentage of packets 1122 is also displayed for reference.

After the test concludes, the user may save the test results by using the save test results control 1124. In embodiments, saving the test results may store the test results to the local machine or transmit the results to a remote machine for storage. In another embodiment, the test results may be saved to a removable media (e.g., a flash card, USB device, optical drive, or the like). In another embodiment, the test results may be stored on a magnetic strip card and dispensed to the user from the wagering game machine. The test results can be time stamped for future reference. Referring to time stamped test results regularly over a period of time may provide insight into network performance degradation or other network issues. Optionally, the user may print the test results using the print test results control 1126. For example, the test results may be printed in a summary format to a ticket and dispensed from a ticket printer built into the wagering game machine. The test results may also be printed to a networked printer.

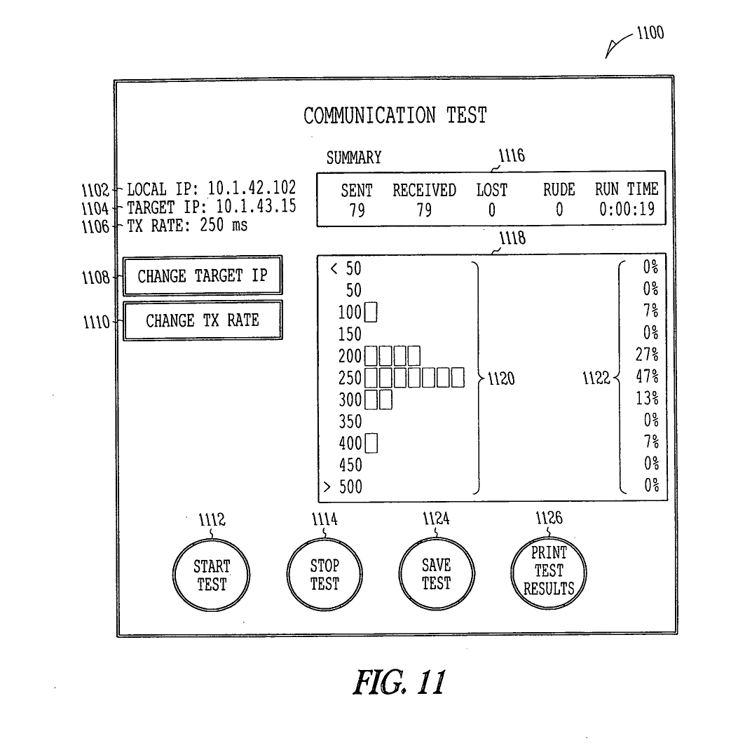

FIG. 12 is a data flow diagram illustrating a test transmission, according to example embodiments. At 1200, a diagnostic request is received at Node 1. For example, referring to FIG. 11, the start test control 1112 may be activated to begin testing. At 1202, one or more test transmissions are generated and sent to a target machine (Node 2). The target machine recognizes 1204 the test transmissions and responds 1206. As response transmissions are received by the requesting machine (Node 1), the transmissions are analyzed and results are accumulated 1208. Analysis may include recording and reporting the minimum, maximum, and average transmission time, either round trip or one-way. Analysis may also include statistical information related to the number of messages sent, received, or lost. Analysis may also include the number of “hops” or stops along the way between the originating node and the receiving node. The hops may include switches, routers, buses, gateways, repeaters, etc.

FIG. 13 is a diagram illustrating a relationship between network protocol stacks, according to example embodiments. In FIG. 13, lower levels generally provide network services and connectivity for the upper layers. For example, the protocol stack illustrated in FIG. 13 includes an Ethernet layer 1300, an IP layer 1302, a UDP/TCP layer 1304, a proprietary networking layer 1306, and a proprietary application layer 1308. The Ethernet layer 1300 corresponds roughly with the OSI Physical Layer (portions of Ethernet are associated with the Physical Layer while other portions are associated with the Data Link Layer). The IP layer 1302 corresponds with the OSI Network Layer, while the UDP/TCP layer 1304 corresponds with the OSI Transport Layer. The proprietary networking layer 1306 is used to provide an abstraction between the proprietary application layer 1308 and the UDP/TCP layer. When a transmission packet is formed, each layer may include header information to facilitate the transmission from the source node to the destination node. When the transmission is received, each layer in the stack may read, use, and then remove the appropriate header information. Thus, each protocol layer at the source node can be considered to have a virtual connection 1310 to a corresponding protocol layer at the destination node. Diagnostics may be performed at each layer using the virtual connections 1310. For example, messages may be generated at a particular protocol level on one node and sent to the corresponding protocol level on one or more other nodes. The user can then isolate connection or communication problems, for example, by observing when one layer fails while layers underneath it can communicate.

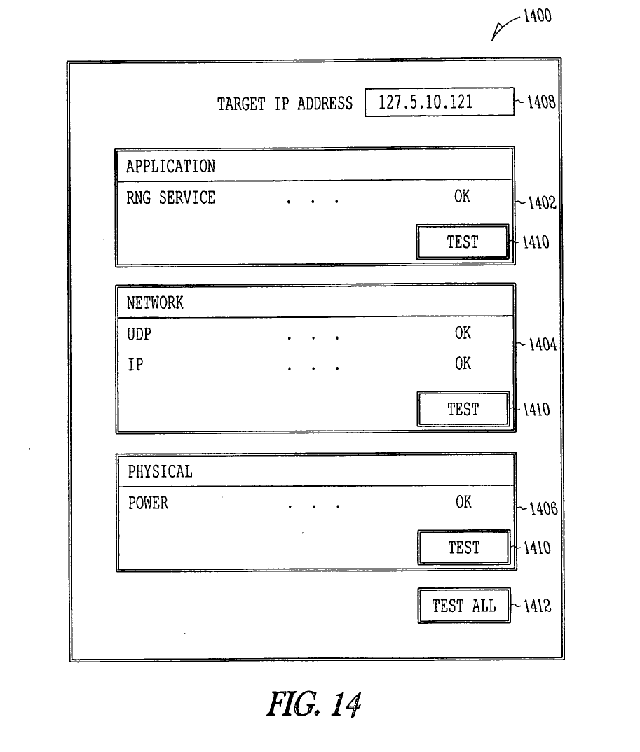

FIG. 14 is a diagram illustrating a component test screen 1400, according to example embodiments. In an embodiment, the component test screen 1400 is displayed when a system is in component diagnostic mode 416. In an embodiment, the component test screen 1400 is organized according to an underlying protocol description. The underlying protocol description may be based on a standardized protocol description (e.g., the Open System Interconnection Reference Model, also referred to as the OSI Seven Layer Model) or a proprietary protocol description. In general, a protocol description may be constructed to include a physical layer (e.g., the physical transmission medium), a networking layer (e.g., the Data Link, Network, and Transport Layers from the OSI Model), and an application layer (e.g., the Presentation and Application layers from the OSI Model). In the component test screen 1400, the components are arranged according to their relationship to the underlying protocol description. A user can enter an IP address in the target IP address control 1408 and run tests at each component level individually using the corresponding test control 1410. Alternatively, the user can run all tests using the test all control 1412. When all tests are executed together, the tests may be run in a top-down (e.g., from the top of the protocol stack to the bottom, application to physical) or from the bottom-up. In an embodiment, the user can control the configuration or order of the tests when run together.

In the example illustrated, an application section 1402, a network section 1404, and a physical section 1406 are shown. The application section 1402 can include information related to applications, services, user-space daemons, or other software that executes on top of the kernel or other operating system software. For example, if the user provides an IP address corresponding to a random number generator server, the application section 1402 may test for and display results of whether the a random number generator (RNG) service is available. As another example, if the user provides the IP address of a game server, the application section may test for and provide results of whether a connection to a wagering game server is active or whether one or more applications, services, or other software is active or responding.

The network section 1404 can include indications of whether different portions of the network stack of a target machine are operating correctly. For example, the network section 1404 can show the status of an IP network layer and a UDP transport layer. In other embodiments, other standard network protocols (e.g., TCP, IPSec, or IPX) or layers (e.g., session layer) may be tested and displayed. In yet other embodiments, one or more proprietary networking layers may be tested and displayed. Testing may be implemented using standard tools such as ping or proprietary tools.

The physical section 1406 can include an indication of whether the physical connection to the target machine is active. In some embodiments, the physical section 1406 may include detailed information, such as power levels, signal strength, or uptime.

In some embodiments, the results of testing the application, network or physical connections or availability may be used to ensure proper operation. For example, in an embodiment, the wagering game machine may periodically or regularly query one or more machines on the network to ensure that network connectivity or a service is available. For example, a wagering game network can include one or more wagering game machines, one or more wagering game servers to implement networked wagering games, a random number generator server to provide a controlled source of random numbers for use in wagering games, a local name server to provide computer name resolution or computer service resolution, a software server to provide updates or software packages to wagering game machines or servers, a certificate management system server to provide security certificates for encryption and other secured transmission of game data or player data, and an accounting system server to provide functionality for player accounts. In an embodiment, the wagering game machine is configured to disable game play if any of the servers are unavailable. The wagering game machine may transmit an alert or alarm to a wagering game server, an operator, or another system to indicate its state.

FIG. 15 is a diagram illustrating a remote test screen 1500, according to example embodiments. In an embodiment, the remote test screen 1500 is displayed when a system is in remote diagnostic mode 418. In the example shown, two primary functions are available to the user. First, the user can instruct a remote node to send one or more packets to a specified destination. The remote node may be a networked device that does not have a typical user-interface. Using the remote IP control 1502, the user can specify the source of the test packets. The user can then specify the number of packets to send using the packets control 1504 and the destination IP address using the destination IP control 1506. In an embodiment, the destination IP address may be the local IP address, so the user can observe network traffic coming in to the local machine. In embodiments, the remote IP control 1502 and/or the destination IP control 1506 may be presented as restricted (e.g., dropdown, option group, etc.) or unrestricted (e.g., text input) input controls. Similarly, the packet control 1504 may be a restricted or unrestricted control. In the example shown, two test modes are provided to the user, a one-way and a two-way mode. Using the radio control 1508, the user can indicate which test mode to use. The user may then initiate the test using the start test control 1510.

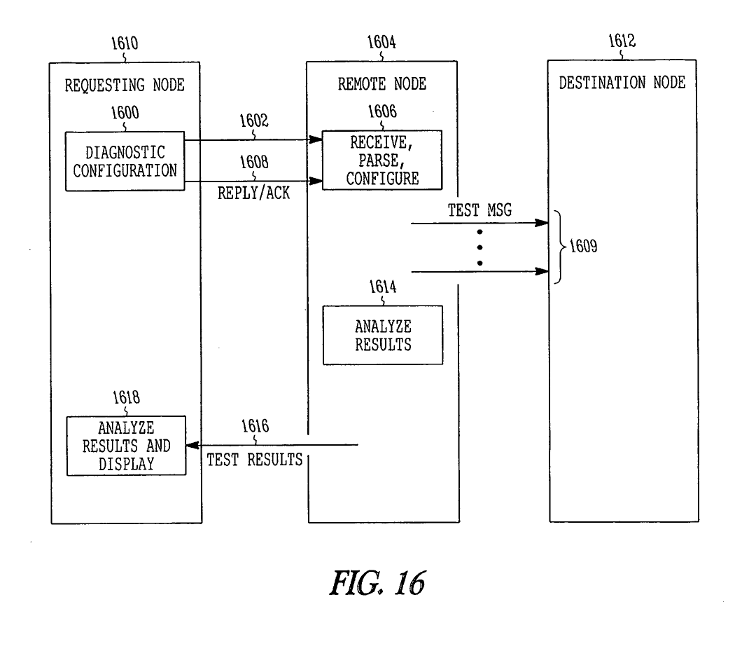

FIG. 16 is a control flow diagram illustrating a one-way test mode, according to example embodiments. At 1600, a diagnostic configuration is determined. For example, using a user-interface such as one illustrated in FIG. 15, a user can provide information to configure the diagnostic test. The diagnostic configuration can include at least the number of packets to be sent, the remote IP address and the IP address of the destination node. In some embodiments, the IP address of the destination node is the IP address of the local machine. The diagnostic configuration is sent 1602 to a remote node 1604 using the remote IP address, where the configuration is received, parsed, and used to configure 1606 the remote node 1604 to perform the requested diagnostic test. An acknowledgement or reply message 1608 is returned to the requesting node 1610. The remote node 1604 can then generate the specified number of test packets 1609 to the destination node 1612. In an embodiment, a ping mechanism is used and one or more round trip response times are recorded. The results can be analyzed 1614, for example, results may be accumulated and summarized, and the test results are communicated 1616 to the requesting node 1610. Once the requesting node 1610 has the test results, it may display 1618 or otherwise make them available to the user.

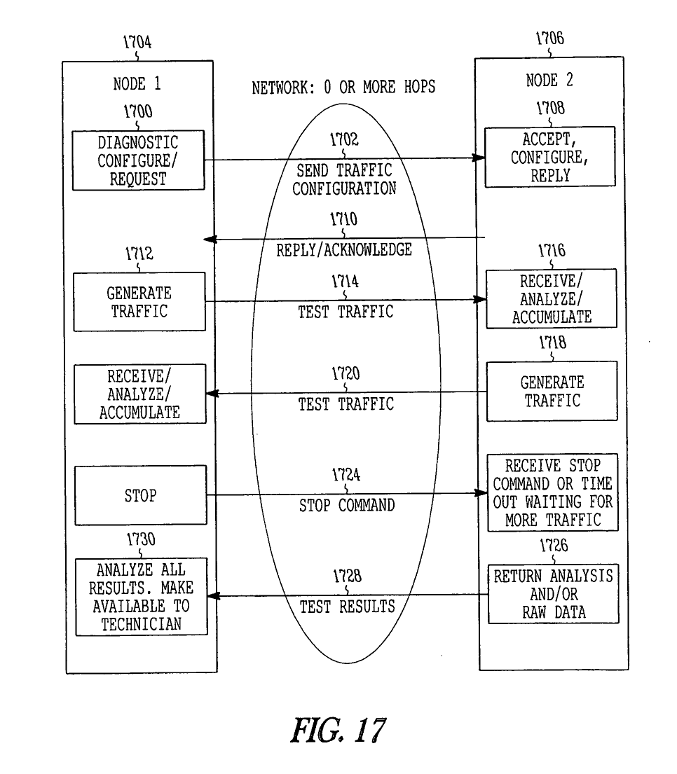

FIG. 17 is a control flow diagram illustrating a two-way test mode, according to example embodiments. At 1700, a diagnostic configuration is determined. Similar to that described in FIG. 16, the configuration may be compiled using a user-interface, such as one illustrated in FIG. 15. The diagnostic configuration can include at least the remote IP address and the destination IP address. The diagnostic configuration is sent 1702 from a requesting node 1704 to the remote node 1706 using the remote IP address in the diagnostic configuration. At 1708, the remote node 1706 can accept, configure, and reply to the diagnostic configuration request. If the remote node 1706 is busy, for example performing another diagnostic test, the reply 1710 may include an indication that the diagnostic configuration request was denied. If the remote node 1706 is otherwise available, then reply 1710 may include an acknowledgement and the testing process may continue. In the example shown in FIG. 17, the destination IP address is the local machine's IP address. In other embodiments, the destination IP address refers to a third node, such as in the example shown in FIG. 16. In a three-node configuration, the remote note 1706 can pass diagnostic configuration request to the destination node (third node) and then run the appropriate test if the destination node is available. Test results can be collected at the remote node 1706 and passed through to the requesting node 1704.

Returning to the two-node example as shown in FIG. 17, if the request is acknowledged, then test traffic is generated 1712 and sent 1714 to the remote node 1706. The remote node 1706 can receive 1716 the test traffic and process it. Then the remote node 1706 can generate its own test traffic 1718 and send 1720 it to the requesting node 1704. The requesting node 1704 can similarly receive 1722 it and process it. The sending and receiving of test traffic may continue for a determined amount of time or for a determined number of packets, for example, using a number of packets to be sent from the diagnostic configuration. Test traffic may contain data, such as a time stamp, to allow the receiving node to calculate a transmission time. By analyzing test traffic from each direction individually, the user may be able to determine network issues not readily available when using round trip communication times. At some point, the requesting node 1704 may send a stop message 1724. In response to the stop message, the remote node 1706 can collect 1726 the traffic data and send 1728 it to the requesting node 1704. In another embodiment, the requesting node 1704 may just stop sending test traffic and after a timeout, the remote node 1706 can consider the test to be terminated. At which point, the remote node 1706 will collect 1726 the traffic data and send 1728 it to the requesting node 1704. The requesting node 1704 can then collect results 1730 accumulated from receiving test traffic and the results from the remote node 1704 and present it to the user.

Referring now to FIG. 15, test results from a one-way or two-way mode test may be displayed in one or more test results views 1512. In embodiments, test result views 1512 may be presented as a table, a textual display, a chart, or a histogram. In the example illustrated, the test results views 1512 are based on a two-way test. The two-way test results include the number of packets received, the transmission time of each packet received, the minimum transmission time (fastest), the maximum transmission time (slowest), and the average transmission time. A one-way test result output may display results such as the packet size, the number of packets sent, the number of packets received, the number of packets lost, the percentage of packets received or lost, the round trip time for each packet sent and received, the minimum round trip time, the maximum round trip time, and the average round trip time. Other statistics may be derived and displayed for one-way or two-way tests. In addition, more or fewer statistics may be displayed in the test results views 1512 and each view may be configurable by the user.

In an embodiment, additional controls may be available on the remote testing screen 1500 to allow a user to specify the type of packet to send. For example, the user may select either TCP packets or UDP packets to be sent to the destination IP. Other packet types may be supported and used, such as proprietary networking packets.

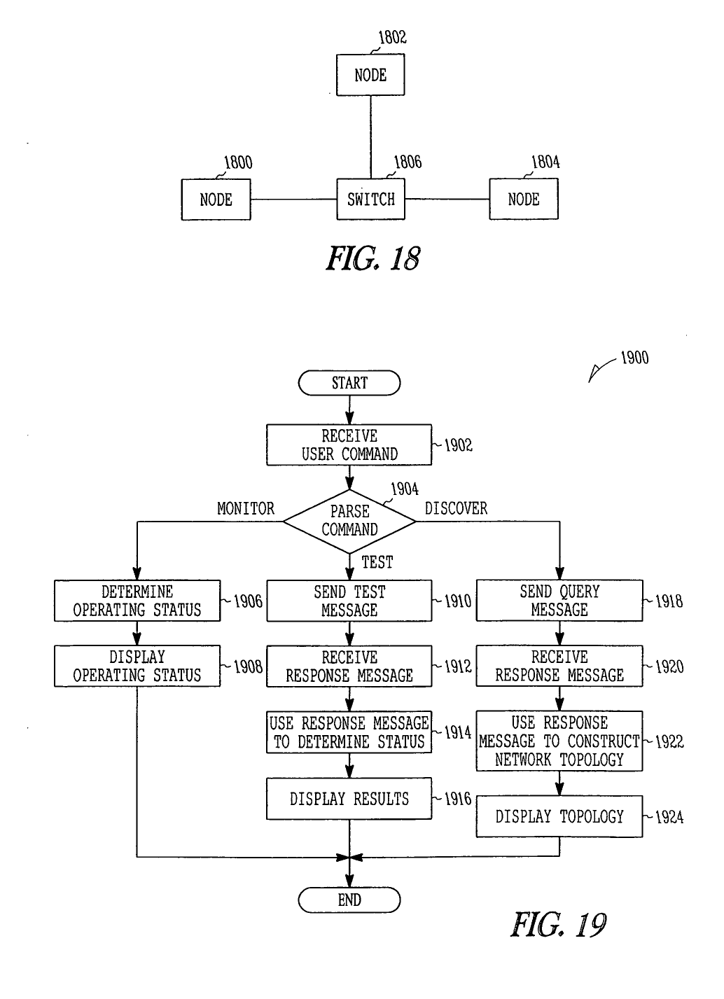

FIG. 18 is an example use of a one-way mode test to detect network connectivity failure, according to example embodiments. In the example, a first node 1800, a second node 1802, and a third node 1804 are connected to a switch 1806. Because of some unknown networking failure, the first node 1800 cannot communicate with the third node 1804, but it can communicate with the second node 1802. Using the one-way mode test, such as described in FIG. 16, a user may request that the second node 1802 attempt to communicate with a destination node (i.e., the third node 1804). The second node 1802 can attempt to send communications to the third node 1804, but it is assumed that in the scenario depicted in FIG. 18, the communications will fail. At the end of remote testing, the second node 1802 can return its test results to the requesting node (i.e., the first node 1802) indicating failure to communicate with the third node 1804. The user, viewing such results, may be able to determine with greater confidence that the connection failure is not due to the first node's 1800 connection to the switch 1806, seeing as how the first node 1800 is able to communicate with the second node 1802, but rather that it is more likely that the connection failure is related to the third node's 1804 connection to the switch 1806.

In embodiments, the one-way mode testing may be used in combination with the discovery screen 800, as illustrated and discussed in FIG. 8, to display broken network connection links. For example, a baseline network topology may be referenced to determine nodes that should be accessible. If after discovery, one or more nodes are not discovered, one-way mode testing may be used to diagnose and isolate network connectivity problems.

FIG. 19 is a flowchart illustrating a method 1900 of using a network diagnostic interface in a wagering game machine, according to example embodiments. At 1902, a command is received. In an embodiment, the command is received from a user using an user-interface, such as one described herein. In alternative embodiments, the command is received from a script, automated job, or remote device. The command may be received at periodic or recurring intervals, for example, on a scheduled basis. At 1904, the command is parsed. Using the results of decision block 1904, if the command indicates that a monitoring operation is to be performed, at 1906, an operating status is determined. In various embodiments, the operating status includes one or more of a networking operating status (e.g., connection status, connection speed, link type, address information, etc.), a machine operating status (e.g., processor usage, memory usage, uptime, etc.), or a software operating status (e.g., game software operation status, operating system operation status, network software status, etc.). At 1908, the operating status is displayed.

At 1910, if the command parsed at decision block 1904 indicates that a test operation is to be performed, one or more test messages are sent to one or more network nodes. In an embodiment, the test messages include an instruction to perform a remote test, such as described above with respect to FIGS. 15-17. In an embodiment, the test messages include a standardized message, such as a ping, SNMP (Simple Network Management Protocol), or tracert (trace route) message, for example. In an embodiment, the test messages include customized messages, such as for use between two or more proprietary applications.

At 1912, one or more response messages are received. The response messages may include request information, status information, a responsive requested operation, or an acknowledgement, in various embodiments. At 1914, the response messages can be used to determine a status. For example, a network status can be determined by analyzing the response message to a ping-like test message. As another example, a custom test message can request the operational status of a service (e.g., a random number generator service on a remote machine) and can prompt a response, which can be analyzed to determine the operational status of the remote service. At 1916, the responses are displayed in a formatted output. The output can include a graph, a list, a textual display, or a histogram, in various embodiments.

At 1918, if the command parsed at decision block 1904 indicates that a discover operation is to be performed, one or more query messages are sent to one or more network nodes. The query messages can be used to prompt a reply from each network node indicating whether or not they are available (e.g., connected to the network or accessible to the requesting network node). At 1920, one or more response messages are received from the queried network nodes. The response messages can include data, such as an identification of the responding network node, a list of services available on the network node, a list of software on the network node, or other operational information associated with the responding network node. At 1922, the network topology is constructed using the response messages from the responding network nodes. At 1924, the network topology is displayed. The topology may be displayed in a graphical form (e.g., pictorial representation of the network and each node) or in a textual format (e.g., a list of nodes and associated characteristics).

Some or all of the screens illustrated in FIGS. 5-11 and FIGS. 14 and 15 may be combined into a cohesive user-interface. In an embodiment, access to one or more screens is secured. For example, in a wagering game machine a casino operator may need to access an information screen, such as one illustrated in FIG. 7; however, access to a game configuration screen may be restricted to employees of the provider of the wagering game machine. In various embodiments, security access may use the operator's identity, role, access level, or other security indicia. In embodiments, security access may use other factors, such as the time of day, the day of week, the type of machine, the location of the machine on a network, the physical location of the machine, the type or version of the operating system or other software, the type of version hardware devices associated with the machine, and the like, to determine the amount or level of access to a portion of the user-interface.

### Example Wagering Game Machines

### Example Wagering Game Machine

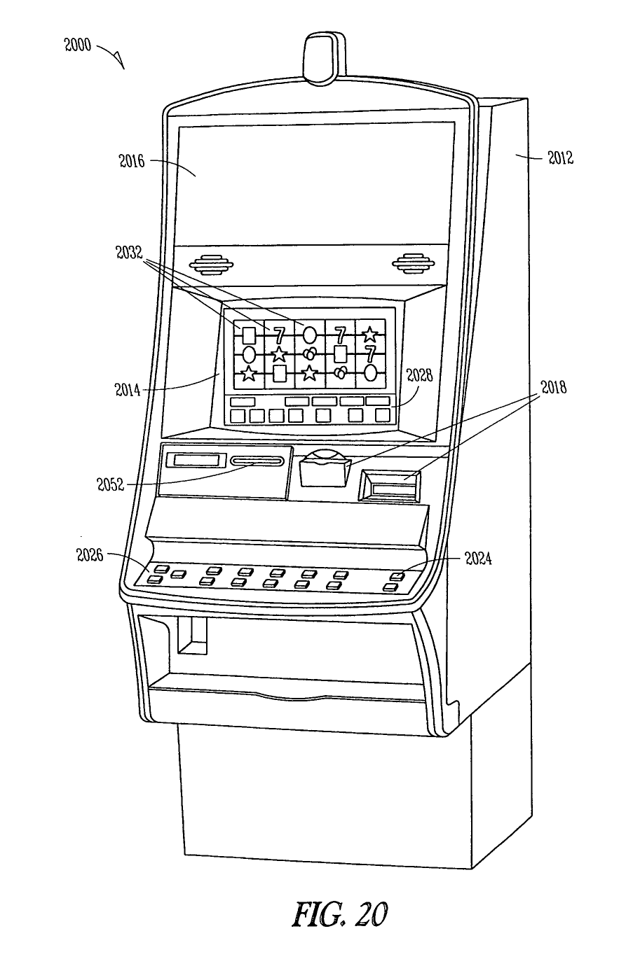

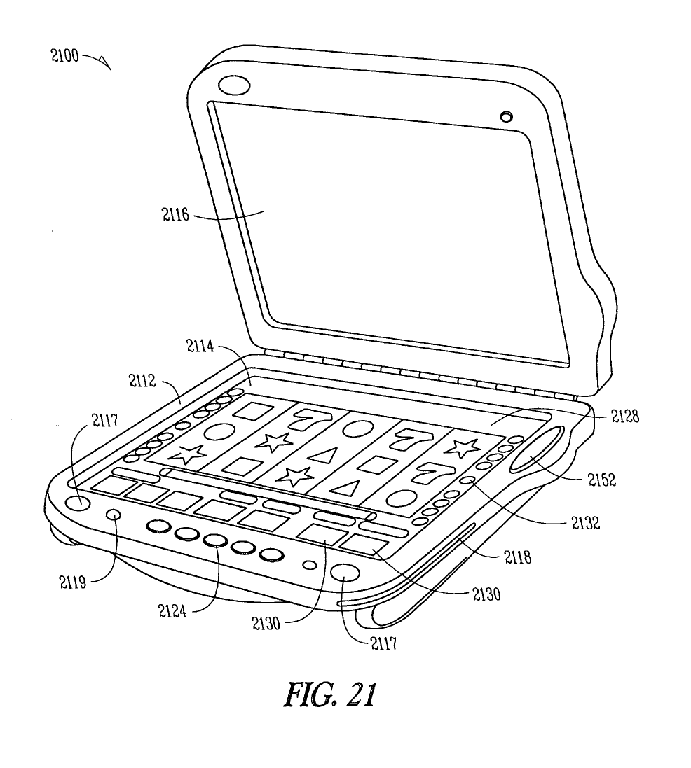

FIG. 20 is a perspective view of a wagering game machine, according to example embodiments. Referring to FIG. 20, a wagering game machine 2000 is used in gaming establishments, such as casinos. According to embodiments, the wagering game machine 2000 can be any type of wagering game machine and can have varying structures and methods of operation. For example, the wagering game machine 2000 can be an electromechanical wagering game machine configured to play mechanical slots, or it can be an electronic wagering game machine configured to play video casino games, such as blackjack, slots, keno, poker, blackjack, roulette, etc.

The wagering game machine 2000 comprises a housing 2012 and includes input devices, including value input devices 2018 and a player input device 2024. For output, the wagering game machine 2000 includes a primary display 2014 for displaying information about a basic wagering game. The primary display 2014 can also display information about a bonus wagering game and a progressive wagering game. The wagering game machine 2000 also includes a secondary display 2016 for displaying wagering game events, wagering game outcomes, and/or signage information. While some components of the wagering game machine 2000 are described herein, numerous other elements can exist and can be used in any number or combination to create varying forms of the wagering game machine 2000.

The value input devices 2018 can take any suitable form and can be located on the front of the housing 2012. The value input devices 2018 can receive currency and/or credits inserted by a player. The value input devices 2018 can include coin acceptors for receiving coin currency and bill acceptors for receiving paper currency. Furthermore, the value input devices 2018 can include ticket readers or barcode scanners for reading information stored on vouchers, cards, or other tangible portable storage devices. The vouchers or cards can authorize access to central accounts, which can transfer money to the wagering game machine 2000.

The player input device 2024 comprises a plurality of push buttons on a button panel 2026 for operating the wagering game machine 2000. In addition, or alternatively, the player input device 2024 can comprise a touch screen 2028 mounted over the primary display 2014 and/or secondary display 2016. In some cases, the player input device 2024 is referred to as a user-input device, human interface device, or player interface device. This device category may include other I/O devices that are integrated, attached to, or otherwise communicate with the wagering game machine 2000. For example, an information reader 2052 may be used to read or write to RFID media, bar coded tickets, magnetic strip cards, USB keycards, or jump drive devices provided by a player or user.

The various components of the wagering game machine 2000 can be connected directly to, or contained within, the housing 2012. Alternatively, some of the wagering game machine's components can be located outside of the housing 2012, while being communicatively coupled with the wagering game machine 2000 using any suitable wired or wireless communication technology.

The operation of the basic wagering game can be displayed to the player on the primary display 2014. The primary display 2014 can also display a bonus game associated with the basic wagering game. The primary display 2014 can include a cathode ray tube (CRT), a high resolution liquid crystal display (LCD), a plasma display, light emitting diodes (LEDs), or any other type of display suitable for use in the wagering game machine 2000. Alternatively, the primary display 2014 can include a number of mechanical reels to display the outcome. In FIG. 20, the wagering game machine 2000 is an “upright” version in which the primary display 2014 is oriented vertically relative to the player. Alternatively, the wagering game machine can be a “slant-top” version in which the primary display 2014 is slanted at about a thirty-degree angle toward the player of the wagering game machine 2000. In yet another embodiment, the wagering game machine 2000 can exhibit any suitable form factor, such as a free standing model, bartop model, mobile handheld model, or workstation console model.

A player begins playing a basic wagering game by making a wager via the value input device 2018. The player can initiate play by using the player input device's buttons or touch screen 2028. The basic game can include arranging a plurality of symbols along a payline 2032, which indicates one or more outcomes of the basic game. Such outcomes can be randomly selected in response to player input. At least one of the outcomes, which can include any variation or combination of symbols, can trigger a bonus game.

In some embodiments, the wagering game machine 2000 can also include an information reader 2052, which can include a card reader, ticket reader, bar code scanner, RFID transceiver, or computer readable storage medium interface. In some embodiments, the information reader 2052 can be used to award complimentary services, restore game assets, track player habits, etc.

### Example Mobile Wagering Game Machine

FIG. 21 is a perspective of a mobile wagering game machine 2100, according to an example embodiment. Like free standing wagering game machines, in a handheld or mobile form, the mobile wagering game machine 2100 can include any suitable electronic device configured to play a video casino games such as blackjack, slots, keno, poker, blackjack, and roulette. The mobile wagering game machine 2100 comprises a housing 2112 and includes input devices, including a value input device 2118 and a player input device 2124. For output, the mobile wagering game machine 2100 includes a primary display 2114, a secondary display 2116, one or more speakers 2117, one or more player-accessible ports 2119 (e.g., an audio output jack for headphones, a video headset jack, etc.), and other conventional I/O devices and ports, which may or may not be player-accessible. In the embodiment depicted in FIG. 21, the mobile wagering game machine 2100 comprises a secondary display 2116 that is rotatable relative to the primary display 2114. The optional secondary display 2116 can be fixed, movable, and/or detachable/attachable relative to the primary display 2114. Either the primary display 2114 and/or secondary display 2116 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and wagering game machine status.

The player-accessible value input device 2118 can comprise, for example, a slot located on the front, side, or top of the housing 2112 configured to receive credit from a stored-value card (e.g., casino card, smart card, debit card, credit card, etc.) inserted by a player. The player-accessible value input device 2118 can also comprise a sensor (e.g., an RF sensor) configured to sense a signal (e.g., an RF signal) output by a transmitter (e.g., an RF transmitter) carried by a player. The player-accessible value input device 2118 can also or alternatively include a ticket reader, or barcode scanner, for reading information stored on a credit ticket, a card, or other tangible portable credit or funds storage device. The credit ticket or card can also authorize access to a central account, which can transfer money to the mobile wagering game machine 2100.

Still other player-accessible value input devices 2118 can require the use of touch keys 2130 on the touch-screen display (e.g., primary display 2114 and/or secondary display 2116) or player input devices 2124. Upon entry of player identification information and, preferably, secondary authorization information (e.g., a password, PIN number, stored value card number, predefined key sequences, etc.), the player can be permitted to access a player's account. As one potential optional security feature, the mobile wagering game machine 2100 can be configured to permit a player to only access an account the player has specifically set up for the mobile wagering game machine 2100. Other conventional security features can also be utilized to, for example, prevent unauthorized access to a player's account, to minimize an impact of any unauthorized access to a player's account, or to prevent unauthorized access to any personal information or funds temporarily stored on the mobile wagering game machine 2100.

The player-accessible value input device 2118 can itself comprise or utilize a biometric player information reader which permits the player to access available funds on a player's account, either alone or in combination with another of the aforementioned player-accessible value input devices 2118. In an embodiment wherein the player-accessible value input device 2118 comprises a biometric player information reader, transactions such as an input of value to the mobile wagering game machine 2100, a transfer of value from one player account or source to an account associated with the mobile wagering game machine 2100, or the execution of another transaction, for example, could all be authorized by a biometric reading, which could comprise a plurality of biometric readings, from the biometric device.

Alternatively, to enhance security, a transaction can be optionally enabled only by a two-step process in which a secondary source confirms the identity indicated by a primary source. For example, a player-accessible value input device 2118 comprising a biometric player information reader can require a confirmatory entry from another biometric player information reader 2152, or from another source, such as a credit card, debit card, player ID card, fob key, PIN number, password, hotel room key, etc. Thus, a transaction can be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 2118 can be provided remotely from the mobile wagering game machine 2100.

The player input device 2124 comprises a plurality of push buttons on a button panel for operating the mobile wagering game machine 2100. In addition, or alternatively, the player input device 2124 can comprise a touch screen mounted to a primary display 2114 and/or secondary display 2116. In one aspect, the touch screen is matched to a display screen having one or more selectable touch keys 2130 selectable by a user's touching of the associated area of the screen using a finger or a tool, such as a stylus pointer. A player enables a desired function either by touching the touch screen at an appropriate touch key 2130 or by pressing an appropriate push button on the button panel. The touch keys 2130 can be used to implement the same functions as push buttons. Alternatively, the push buttons 2132 can provide inputs for one aspect of the operating the game, while the touch keys 2130 can allow for input needed for another aspect of the game. The various components of the mobile wagering game machine 2100 can be connected directly to, or contained within, the housing 2112, as seen in FIG. 21, or can be located outside the housing 2112 and connected to the housing 2112 via a variety of wired (tethered) or wireless connection methods. Thus, the mobile wagering game machine 2100 can comprise a single unit or a plurality of interconnected (e.g., wireless connections) parts which can be arranged to suit a player's preferences. In some cases, the player input device 2124 is referred to as a user-input device, human interface device, or player interface device.

The operation of the basic wagering game on the mobile wagering game machine 2100 is displayed to the player on the primary display 2114. The primary display 2114 can also display the bonus game associated with the basic wagering game. The primary display 2114 preferably takes the form of a high resolution LCD, a plasma display, an LED, or any other type of display suitable for use in the mobile wagering game machine 2100. The size of the primary display 2114 can vary from, for example, about a 2-3″ display to a 15″ or 17″ display. In at least some embodiments, the primary display 2114 is a 7″-10″ display. In one embodiment, the size of the primary display can be increased. Optionally, coatings or removable films or sheets can be applied to the display to provide desired characteristics (e.g., anti-scratch, anti-glare, bacterially-resistant and anti-microbial films, etc.). In at least some embodiments, the primary display 2114 and/or secondary display 2116 can have a 16:9 aspect ratio or other aspect ratio (e.g., 20:3). The primary display 2114 and/or secondary display 2116 can also each have different resolutions, different color schemes, and different aspect ratios.

As with the free standing embodiments a wagering gaming machine, a player begins play of the basic wagering game on the mobile wagering game machine 2100 by making a wager (e.g., via the value input device 2118 or an assignment of credits stored on the handheld gaming machine via the touch screen keys 2130, player input device 2124, or buttons 2132) on the mobile wagering game machine 2100. In some embodiments, the basic game can comprise a plurality of symbols arranged in an array, and includes at least one payline 2128 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 2118 of the mobile wagering game machine 2100 can double as a player information reader 2152 that allows for identification of a player by reading a card with information indicating the player's identity (e.g., reading a player's credit card, player ID card, smart card, etc.). The player information reader 2152 can alternatively or also comprise a bar code scanner, RFID transceiver or computer readable storage medium interface. In one embodiment, the player information reader 2152 comprises a biometric sensing device.

### General

In this detailed description, reference is made to specific examples by way of drawings and illustrations. These examples are described in sufficient detail to enable those skilled in the art to practice the inventive subject matter, and serve to illustrate how the inventive subject matter can be applied to various purposes or embodiments. Other embodiments are included within the inventive subject matter, as logical, mechanical, electrical, and other changes can be made to the example embodiments described herein. Features or limitations of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims.

Each of the embodiments described herein are contemplated as falling within the inventive subject matter, which is set forth in the following claims.

1. An apparatus comprising:
a wagering game unit operable to receive a wager in association with a wagering game; and
a network diagnostics unit operable to determine a network state.

2. The apparatus of claim 1, wherein the network diagnostics unit is further operable to:
send a test message to a destination network node; and
receive a reply message related to the test message.

3. The apparatus of claim 2, wherein the network diagnostics unit is further operable to use the reply message to determine a network connectivity state or a network latency measurement.

4. A method of operating a computerized wagering game system, comprising:
presenting a wagering game upon which monetary value can be wagered; and
determining a state of a network connection between the wagering game system and a networked device, wherein determining the state comprises analyzing a message received from the networked device.

5. The method of claim 4, further comprising sending a test message to a device, wherein the test message prompts the networked device to transmit a response message to the computerized wagering game system.

6. The method of claim 4, further comprising:
using the received message to determine a network connectivity state or a network latency measurement.

7. A computerized wagering game system, comprising:
a display;
a network communication device;
a user-input device; and
a processor configured to operate in:
a first mode of operation, wherein the first mode is configured to present a wagering game on the display; and
a second mode of operation, wherein the second mode is configured to present a network diagnostic interface on the display.

8. The computerized wagering game system of claim 7, wherein the processor is further configured to operate the second mode of operation to:
receive an operational command, wherein the operational command is one of a test command, a monitor command, or a discover command; and
display a result to the display, wherein the result is associated with the command.

9. (canceled)

10. The computerized wagering game system of claim 8, wherein the test command causes the computerized wagering game system to:
send a test message to a destination network node via the network communication device;
receive a response message from the destination network node via the network communication device; and
use the response message to determine the result, wherein the result includes at least one of a status of the destination network node, a network latency to the destination network node, or an availability of a service associated with the destination network node.

11. The computerized wagering game system of claim 8, wherein the test command causes the computerized wagering game system to:
determine an operating status of a network node; and
provide the operating status as the result.

12. The computerized wagering game system of claim 8, wherein the discovery command causes the computerized wagering game system to:
send a query message to a network node via the network communication device;
receive a response message from the network node via the network communication device; and
use the response message to determine the result, wherein the result includes information used to construct a network topology including the network node.

13. (canceled)

14. The computerized wagering game system of claim 7 further comprising:
a first interface to control the first mode of operation; and
a second interface to control the second mode of operation, wherein the second interface comprises a network management interface including one or more of a diagnostic interface, a monitoring interface, a testing interface, a status interface, a network discovery interface, a statistics interface, or an information interface.

15. The computerized wagering game system of claim 14, wherein the diagnostic interface comprises:
a general diagnostics view to display a status of a component of the computerized wagering game system, the component including one or more of wagering game software, wagering game hardware, network components, or operating system software; and
a detailed diagnostics view to display a detailed diagnostic test result view.

16. The computerized wagering game system of claim 15, wherein the detailed diagnostic test result view includes a network communication test result view to display at least one of a network connectivity or a network latency between a first and second network node.

17. The computerized wagering game system of claim 15, wherein the detailed diagnostic test result view includes a computerized wagering game system component test result view to display at least one of an application component status, a network component status, or a physical component status of a target computerized wagering game system.

18. The computerized wagering game system of claim 15, wherein the detailed diagnostic test result view includes a remote computerized wagering game system testing view to display at least one of a network latency between a remote node and a destination node, or a network connectivity between the remote node and the destination node.

19. The computerized wagering game system of claim 14, wherein the monitoring interface comprises at least one of:
a network information view to display a network status of the computerized wagering game system;
a network-oriented graph to display at least one of a network utilization, a network latency, or a network traffic associated with the computerized wagering game system; or
a network messages view to display at least one of an inter-node network message or an intra-node network message.

20. The computerized wagering game system of claim 19, wherein the network messages view includes a filter control to filter a message using at least one of a message type, a message interface, a process identifier, a network protocol, a message destination, or a message origin.

21. The computerized wagering game system of claim 14, wherein the network discovery interface comprises a graphical representation of a network topology detectable from the computerized wagering game system, the network topology including at least one network node.

22. The computerized wagering game system of claim 21, wherein the network discovery interface further comprises a list view of the at least one network node to display at least one of a network node identification, a network node address, or a network latency associated with the at least one network node.

23. A machine-readable medium including instructions stored thereon that, when performed by a machine, cause the machine to:
present a wagering game upon which monetary value can be wagered; and
determine the state of a network connection between the wagering game system and a networked device, wherein determining the state comprises analyzing a message received from the networked device.

24-25. (canceled)
